(19) United States
(12) Patent Application Publication
(10) Pub. No.: US 2005/0169832 A1
(43) Pub. Date: Aug. 4, 2005

(54) Concurrent packed tower manufacture of hypochlorite

(75) Inventor: Duane Powell, Alma, MI (US)

Correspondence Address: GEORGE LAWRENCE BOLLER, SUITE 316, 17199 N LAUREL PARK DR, LIVONIA, MI, 48152, US

(73) Assignee: Powell Technologies LLC

(21) Appl. No.: 11/047,253

(22) Filed: Jan. 31, 2005

Related U.S. Application Data
(60) Provisional application No. 60/541,219, filed on Feb. 2, 2004.

(51) Int. Cl. C01B 11/06; B01J 8/00

(52) U.S. Cl. 423/473; 422/211; 422/198

(57) ABSTRACT

A process for the production of hypochlorite using a concurrent packed tower (10) to react caustic and chlorine as they pass concurrently through the tower. The packing may be either random packing or structured packing. The process may be either continuous or batch.

### REFERENCE TO A RELATED APPLICATION AND PRIORITY CLAIM

This application claims the priority of Provisional Application No. 60/541,219, filed on 02 Feb. 2004 in the name of DUANE POWELL.

### FIELD OF THE INVENTION

This invention relates to the manufacture of hypochlorite, in particular a process and a plant for the manufacture of sodium or potassium hypochlorite (bleach).

### BACKGROUND OF THE INVENTION

The chlorine that a chlorine plant produces by the electrolysis of brine in a cell or cells is typically hot and saturated with water vapor. The gas pressure is relatively low, ranging from slightly below atmospheric pressure, −8″ H₂O for example, to slightly above atmosphere, 3-4 PSIG for example. Such a plant may also have dry chlorine gas under pressures as high as about 100 psig and various gas streams that have at least some chlorine in them.

The gases in such streams may be very pure chlorine, such as +99% Cl₂ with other trace gases aggregating less than 1%, or they may be waste gas streams having very low chlorine concentrations, as low as about 1% Cl₂ with inert loads running to about 99%.

It has been the industry practice to employ a countercurrent packed tower (a “packed tower” sometimes also being called a “packed” column) for scrubbing the chlorine. A countercurrent packed tower promotes good chlorine reaction characterized by important advantages that include low gas pressure drop, ability to handle gas streams largely independent of inert gas loading, low PPM (parts per million) Cl₂ outlet concentrations, and predictable results.

Other aspects of countercurrent packed tower scrubbing however are potentially detrimental in varying degrees to the hypochlorite manufacturing process. Low excess caustic (less than about 0.2% to about 0.3% by weight NaOH) significantly increases the production of chlorate (NaClO₃) with each 0.1% by weight NaClO₃ produced resulting in the loss of approximately 0.2% weight NaOCl. Side reaction of hypochlorite to chlorate increases salt (NaCl) concentration. Increasing the concentrations of chlorate and salt limit the resulting bleach strength (concentration), with salt concentrations that exceed the solubility limit forming salt crystals that can potentially plug the tower packing.

A hypochlorite process that uses a typical countercurrent packed tower for scrubbing the chlorine may produce (about 12% to about 14% by weight) NaOCl accompanied by about 1.5% by weight excess NaOH and about 1% by weight NaClO₃. 10%-15% of the raw material may be lost because of the amount of NaClO₃ produced. By contrast, high quality hypochlorite is considered to have no more than about 0.3% by weight excess NaOH and about 0.1% by weight NaClO₃.

For maximum utilization of chlorine in a hypochlorite plant, the gas stream introduced into the countercurrent packed tower may either a pure stream or a stream that includes waste gas or gasses.

One process for producing high quality bleach having low chlorate concentration uses ejectors to inject NaOH solution into a chlorine gas stream passing through a reactor. The pressure of the solution must be elevated to some superatmospheric pressure in order for the ejectors to work properly. Electric pumps are used to develop that pressure for forcing the caustic solution through and out of the ejectors. The effectiveness of the reaction depends on the turbulence that is generated in the concurrent flow through the reactor.

The process typically uses pure chlorine gas produced by electrolytic cells and then cooled to a desired temperature (35° C.-40° C. is typical). The cooled chlorine is saturated with water vapor. The pumps and ejectors add cost and complexity to an installation, and they require significant energy input for proper operation. If inert gas is present in the chlorine stream, it can degrade ejector effectiveness.

Another hypochlorite production process uses countercurrent flows through a packed tower where the downward flow of caustic is slowed by the upward flow of chlorine. Increasing the flow rates in order to attain desired production velocities tends to generate foaming (emulsification) of the liquid product being produced in the tower. Such foaming is seen to be detrimental to a continuous process.

Examples of the use of countercurrent flows in the production of hypochlorite are found in U.S. Pat. Nos. 4,330,521 and 4,780,303. In U.S. Pat. No. 4,330,521, the reaction is said to occur in a packed tower.

U.S. Pat. No. 4,744,956 describes a hypochlorite production process in which the caustic and chlorine are introduced concurrently into a flow mixer having a venturi through which the mixture is supplied to an inlet of a multi-stage regenerative turbine pump. The reaction is promoted by the turbulent concurrent flow created by the pumping action with the resulting output from the pump being delivered through a conduit into a tank maintained at superatmospheric pressure.

U.S. Pat. No. 2,889,199 describes a process in which lime slurry and chlorine are introduced concurrently into a mixer and then through a retention pipe where the reaction is said to occur.

An authoritative source on the design and use of packed towers, Packed Tower Design and Applications, by Ralph F. Strigle, Jr., second edition, 1994, observes that packed towers operating with concurrent gas and liquid flows are not widely used and that countercurrent operation provides the greatest efficiency because mass transfer driving forces are at a maximum.

In a conventional countercurrent packed tower for producing hypochlorite, the top of the tower contains a high concentration of caustic in the liquid phase and a low concentration of chlorine in the gas phase. Because the heat of reaction is determined by the mass of chlorine absorbed, only a small quantity of heat is liberated at the top of the tower.

The concentration of chlorine in the gas phase is significantly higher at the bottom of the tower than it is at the top, while the concentration of free caustic in the liquid phase at the bottom of the tower is significantly lower. Hypochlorite in the liquid phase at the bottom of the tower has a fairly strong concentration.

Because a large percentage of chlorine will be absorbed at the bottom of the tower despite the concentration of the free caustic being lower at the bottom than at the top, the quantity of heat released at the bottom of the tower will be significantly greater at the bottom than at the top. In addition, the condensation of water from the saturated chlorine feed into the bottom of the tower will release a significant quantity of heat.

Consequently, the high partial pressure of chlorine at the bottom of the tower can supersaturate the liquid phase at the bottom of the tower before that phase can be diluted by additional downflowing liquid. It is believed that the massive condensation of water vapor occurring at the bottom of the tower tends to strip the supersaturated liquid phase, causing the liquid to foam.

A further complication for countercurrent packed tower production of hypochlorite arises from the inherent chemistry of the process. One of the products of the reaction between chlorine and caustic soda is sodium chloride. The basic chemical reaction for producing sodium hypochlorite is: Cl₂+2NaOH→NaOCl+NaCl+H₂O. If the strength of the caustic that is being fed to the top of the tower is increased in an effort to produce a higher concentration of hypochlorite product, the solubility limit of sodium chloride in the liquid phase may be exceeded, resulting in precipitation of salt. Deposition of solid material like salt crystals in a countercurrent packed tower can significantly reduce the void space in the packing and thus the capacity of the packing.

If the process were 100% efficient, the resulting solution would contain a maximum amount of sodium hypochlorite in the range of about 16.5% to about 17% by weight without any salt removal. However, as the basic reaction is producing hypochlorite, a side reaction involving the hypochlorite is also occurring. That side reaction is the decomposition of some of the hypochlorite represented by this equation 3 NaOCl→NaClO₃+2NaCl. The side reaction is promoted in a standard countercurrent packed tower because of a low amount of excess sodium hydroxide in the bottom of the tower where a high amount of chlorine gas is also present due to the introduction of chlorine into the bottom of the tower. As the amount of excess caustic diminishes in liquid passing through the packing due to the basic reaction with chlorine, the pH of the liquid decreases. The greater abundance of unreacted chlorine in the lower region of the tower further lowers the pH of the liquid. This condition creates localized regions of low alkalinity in the solution, in the range of 9-10 pH for example or even lower. Because the surface edges of the tower packing have significant effect on promoting chemical reactions, they accelerate the side reaction to sodium chlorate and sodium chloride when these regions of low alkalinity in the solution contact them as the solution nears the bottom of the packing.

In countercurrent packed towers that produce sodium hypochlorite with low excess sodium hydroxide levels, the side reaction decomposition of the hypochlorite can result in the loss of chlorine and caustic in the range of 10-15% of the total amount reacted. Furthermore, the additional salt added to the solution near the lower region of the tower because of this decomposition will accelerate the formation of salt crystals at lower sodium hypochlorite concentrations, reducing the maximum strength of sodium hypochlorite being produced. The maximum weight percent of sodium hypochlorite that can be produced using typical countercurrent packed tower technology without risk of plugging the tower with solid sodium chloride crystals, ranges from about 12% to about 14% by weight hypochlorite when the excess sodium hydroxide levels range from about 0.2% to about 0.3% by weight.

Furthermore, not only is the formation of crystalline salt not desired in the final solution, but the nature of the process, in combination with the random or structured packing in the tower, allows the salt crystals to build on the edges of the packing, and if the process conditions are not changed, the salt will eventually build up on the packing to the point of significant blockage of the tower.

To avoid tower plugging by the deposition of crystallizing salt on packing edges, pressure can be monitored by conventional equipment and appropriate measures taken should incipient tower plugging be indicated by increasing pressure drop. However, those measures are at the expense of production efficiency, keeping the practical maximum at the 12%-14% limit and requiring higher levels of excess sodium hydroxide in the sodium hypochlorite solution to increase the pH of the solution in the lower regions of the packed tower to reduce the side reaction of sodium chlorate and salt.

Besides that maximum practical 12%-14% limit, which is significantly below the maximum theoretical limit of about 17%, further adverse ramifications of the countercurrent packed tower process for producing aqueous hypochlorite are: the increased the cost (per unit weight of hypochlorite) of shipping the product to customers; the increased decomposition rate of the sodium hypochlorite due to higher total ionic strength from the additional sodium chlorate and sodium chloride and loss of sales to customers who need low sodium chlorate levels for drinking water purification.

In spite of complications like those just discussed, the continuing use of countercurrent packed towers for the commercial production of hypochlorite suggests that the processes are conducted in ways that allow the complications to be tolerated or to some extent possibly minimized.

### SUMMARY OF THE INVENTION

The present invention involves the discovery that improved efficiencies in the production of hypochlorite can be attained without those complications by a process that uses a concurrent packed tower. While Strigle recognizes that a concurrent packed tower may offer advantages in certain processes, he refers to those where only a single mass transfer stage is required, giving the following as examples: 1) absorption of low concentrations of ammonia by dilute acids; 2) removal of traces of H₂S or CO₂ by absorption into caustic soda solutions; and 3) drying of chlorine gas with recirculated concentrated sulfuric acid.

The present invention enables a plant and process for the production of hypochlorite to be more energy-efficient and to yield improved production efficiencies without generating undesirable foaming or emulsification of the liquid phase. The invention provides improved efficiencies by using less raw materials for a given quantity of hypochlorite produced and in the rate of hypochlorite production for a given rate of mass flow.

In a plant and process embodying principles of the invention, caustic and chlorine are introduced at the top of a concurrent packed tower. Because of the high concentration of caustic in the liquid phase and the high concentration of chlorine in the gas phase, the reaction rate between the two is maximized as they pass downwardly through the packed tower. The absorption of chlorine by the liquid phase and the condensation of water vapor from the gas phase will increase the temperature of the liquid flowing down the tower. That temperature increase will raise the rate of reaction tending to offset the effect of the reduction in the concentrations of the reactants as they are flowing downwardly through the packing. Although a concurrent packed tower may not be capable of removing all the chlorine from the feed gas, it can be suitable when the reactants have a high rate of reaction as they do in the production of hypochlorite. The process reduces the amount of salt in the resulting product because decomposition of hypochlorite produced by the basic process is slowed, yielding hypochlorite strength in the range of about 16.5% to about 17% by weight without salt removal in lieu of the 12% to 14% by weight typical in countercurrent tower production of hypochlorite.

The increased strength of the aqueous hypochlorite product allows significant reduction in freight cost to the customer because the product contains more hypochlorite per unit weight shipped.

In one respect, the present invention relates broadly to a process for the production of hypochlorite using a concurrent packed tower to react the liquid caustic and the chlorine as they pass concurrently through the tower. The packing may be either random packing or structured packing. The process may be either continuous or batch.

In another respect, the present invention relates broadly to a plant that comprises a concurrent packed tower for producing hypochlorite either as an intermediate product or as an end product by reacting the dispersed liquid phase containing (OH)⁻¹ with a continuous gas phase containing Cl₂.

Principles of the invention provide improvements in the production of both sodium hypochlorite and potassium hypochlorite although the somewhat better solubility of the latter perhaps makes tower plugging less problematic in countercurrent production.

Other aspects of the invention relate to more specific attributes of the process and the equipment used to perform the process.

### BRIEF DESCRIPTION OF DRAWINGS

The accompanying drawings, which are incorporated herein and constitute part of this disclosure, illustrate a presently preferred embodiment of the invention, and together with the written description given herein disclose principles of the invention in accordance with a best mode contemplated at this time for carrying out the invention.

FIG. 1 is a schematic diagram of a portion of a hypochlorite plant employing a continuous process in accordance with principles of the present invention.

FIG. 2 is a schematic diagram of a portion of a hypochlorite plant employing a batch process in accordance with principles of the present invention.

### DETAILED DESCRIPTION

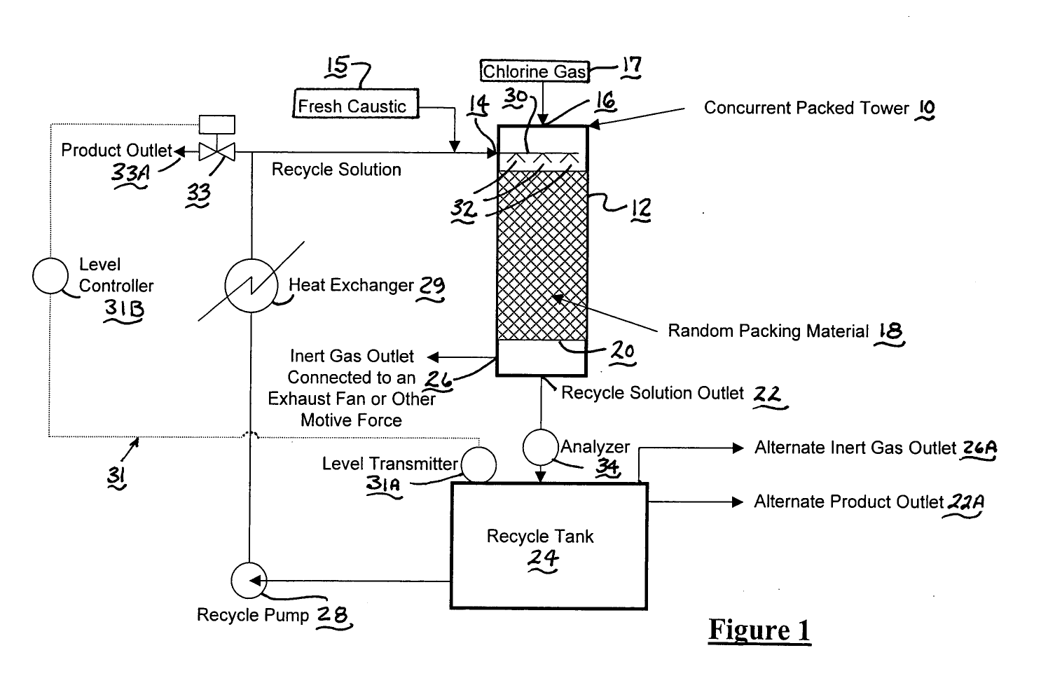

FIG. 1 shows representative plant equipment for a continuous production of sodium hypochlorite. A packed tower 10 comprises a generally vertical housing 12 having two inlets 14, 16. One inlet 14 is for the introduction of liquid that may be a solution of pure caustic (NaOH) from a fresh caustic source 15, a recycle solution, or a mixture of the two; the other inlet 16 is for the introduction of chlorine (Cl₂) from a chlorine source 17. The inlets are proximate the top of housing 12.

The particular embodiments of packed tower shown here use random packing material 18 that is suitably supported within housing 12 on a supporting structure 20 to a desired height below the two inlets. The invention may also be practiced using a tower that has structured packing. Housing 12 further comprises two outlets 22, 26 proximate the bottom of the housing below the supported packing material. Liquid leaves tower 10 through outlet 22 to enter a recycle tank 24, while unreacted chlorine and inert gases are drawn off through outlet 26. Unreacted and inert gases may also, or alternatively, be vented in ways other than through outlet 26, for example from tank 24 via an alternate inert gas outlet 26A. The packing may alternately be structured packing, or a combination of random and structured packing.

A pump 28 draws some of the liquid from tank 24 as recycle solution and recycles the liquid through a heat exchanger 29 that cools the liquid back toward inlet 14 where it can mix with fresh caustic from fresh caustic source 15 prior to introduction to inlet 14. The proportioning of fresh caustic and recycle solution can be controlled in any conventional manner. Aqueous hypochlorite is drawn out of the system as the product of the process at a suitable location.

While it is possible to obtain aqueous hypochlorite product either directly from outlet 22 or from tank 24such as by drawing product through an outlet, shown as alternate product outlet 22A in FIG. 1, at some elevation above the tank bottom, it is preferred to draw product from a location between the outlet of heat exchanger 29 and the location at which fresh caustic from source 15 is introduced. By withdrawing product at that preferred location, the withdrawn product has the benefit of having been cooled to some extent by heat exchanger 29. The withdrawn aqueous hypochlorite can be either an end product or an intermediate product that is used in further processing that ultimately yields an end product.

Within housing 12 is a header 30 containing distribution nozzles 32 suitably arranged to distribute liquid substantially uniformly across the top face of the packing material. Alternately the chlorine may be distributed via multiple nozzles rather than being introduced into the reaction zone via the single inlet entrance that is shown. As the liquid and gas pass downward through the packing, the raw materials react to create the hypochlorite.

An analyzer 34 can be used when it is desired to monitor hypochlorite concentration leaving the packed tower through outlet 22.

For process control of the flow, a level control system 31 comprising a level transmitter 31A and a level controller 31B may be employed. System 31 functions to monitor liquid level in tank 24 via transmitter 31A which in turn furnishes controller 31B with data informing the controller of the liquid level in tank 24. Controller 31B in turn controls a valve 33 such that product is allowed to flow through valve 33 to a product outlet 33A at a rate that maintains a desired liquid level in tank 24.

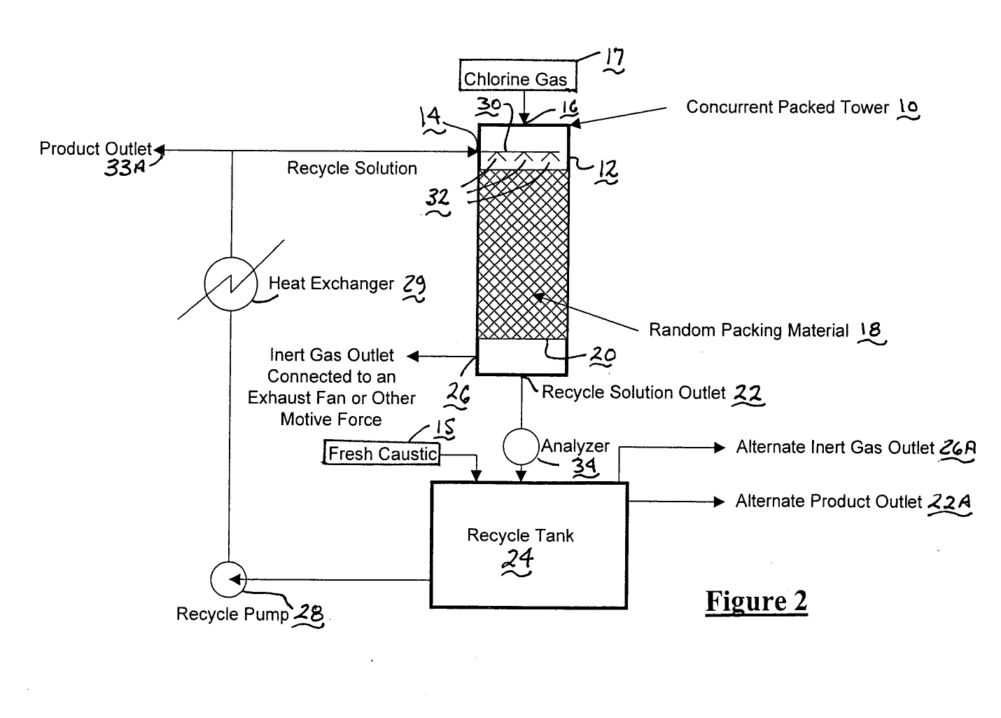

FIG. 2 shows the invention applied to a batch production process. Like reference numerals in both Figures designate like components or elements. In the batch system, some quantity of caustic is introduced into tank 24 at the start of the process and pumped to inlet 14 at the top of the tower by pump 28 where it enters the tower for downward flow through the tower concurrently with chlorine gas introduced at inlet 16. The liquid in tank 24 is recirculated during the process until a desired concentration is indicated by analyzer 34 at which time a valve (not shown) at outlet 33A can be opened to allow the batch of aqueous hypochlorite product that has been produced to be pumped out. In the batch process, it is also preferred to withdraw hypochlorite product downstream of heat exchanger 29, as shown in FIG. 2, to obtain the benefit of cooling the product by the heat exchanger before being pumped out.

The concurrent flow through the packed tower in either a continuous or a batch process provides advantages and benefits for production of either sodium hypochlorite or potassium hypochlorite that include:

1) the ability to produce high-strength hypochlorite (up to about 16.5% to about 17% by weight as limited by the solubility of salt) having very low chlorate concentration at low excess caustic levels (about 0.2% to about 0.3% by weight NaOH typical).

2) the ability to process chlorine (wet or dry) at pressures that can vary over a wide range, such as from −8″ H₂O to 100 PSIG. There is no theoretical limit on the gas or liquid pressure as long as the tower is properly constructed and operated at a lower pressure than the incoming gas; the inlet liquid pressure will of course be at the same pressure as the gas pressure after the liquid leaves the distribution nozzles;

3) the ability to use a wide range of gas ratios (chlorine to inert gases), a 50-1 ratio being typical with the packed tower being designed for the largest inert gas flow, and inherently working for all smaller flows, and the ability to use a wide range of flow turn-downs;

4) the ability to accommodate large liquid flow rates can increase effective cooling, mixing, etc, because the liquid is not slowed by the countercurrent gas flow as it would be in a countercurrent flow process; high recycle rates of liquid enable a low ΔT of the outlet temperature to the inlet recycle temperature. A large quantity of heat is released due to the exothermic reaction of the chlorine and caustic and also the condensation of water vapor. The recycle rate and inert gas load will determine the size of the tower;

5) by avoiding large energy inputs to the liquid phase as is required by the high-pressure ejectors, foaming of the hypochlorite solution can be avoided, even with large flows, eliminating any need for a de-foaming agent.

6) because the force for introducing the liquid into the tower can be small, especially when compared to that required by ejectors, the tower can operate at low pressure, essentially atmospheric, although it can also operate at superatmospheric pressures; the only energy required for the liquid phase is the energy needed to return the recycle liquid to the top of the tower where it can then fall downward under the force of gravity, and that energy can be provided by small horsepower pumps relative to those used in ejector systems; if the tower is operated at significant superatmospheric pressure, higher pressure pumps and more energy will of course be needed to force the liquid into the tower, and in that case gravity may not be the dominant force acting on the liquid.

7) effectiveness of the reaction is less critical because the packed tower can cause any amount of chlorine to be absorbed (90% to 100% is typical)—this is because all excess chlorine goes to a downstream scrubber; what is important is that the sodium hypochlorite/sodium hydroxide solution leaving the bottom of the packed tower have some small amounts of excess caustic in it. Even if there is a small amount of chlorine leaving the tower, it does not seem to create the sodium chlorate levels that would be typical in a countercurrent system where the highest concentration of chlorine reacts with the lowest concentration caustic.

While a presently preferred embodiment of the invention has been illustrated and described, it should be appreciated that principles of the invention are applicable to all embodiments that fall within the scope of the claims that follow hereinafter.

1. A process for producing aqueous hypochlorite in a packed tower, the process comprising:
introducing a liquid comprising caustic and a gas comprising chlorine into a tower for concurrent flow through the tower and causing the concurrent flow to pass through packing that promotes reaction of the caustic and chlorine to produce hypochlorite by dispersion of a liquid phase within a continuous gas phase as the liquid and gas pass concurrently through the packing.

2. A process as set forth in claim 1 in which the concurrent flow within the tower occurs in a downward direction, and the process is controlled to continuously produce aqueous hypochlorite containing about 16.5% to about 17% hypochlorite by weight without salt removal, relatively low excess hydroxide, and relatively low chlorate, essentially free of salt crystallization in the lower region of the tower.

3. A process as set forth in claim 2 wherein the liquid is introduced into the tower through a system that allows gravity to be the dominant force in imparting downward velocity to the liquid.

4. A process as set forth in claim 1 wherein the internal pressure within the tower is at or near atmospheric pressure.

5. A process as set forth in claim 1 wherein both liquid phase and gas phase are introduced into the tower free of any de-foaming agent.

6. A process as set forth in claim 1 wherein the process is conducted on a batch basis by recycling, through the tower, the produced aqueous hypochlorite until a desired concentration of hypochlorite results.

7. A process as set forth in claim 6 including passing the recycled aqueous hypochlorite through an external heat exchanger to cool the liquid before re-introduction into the tower.

8. A process as set forth in claim 7 wherein some aqueous hypochlorite product is withdrawn downstream of the heat exchanger.

9. A process as set forth in claim 1 wherein the process is conducted on a continuous basis by recycling some of the produced aqueous hypochlorite, adding fresh caustic to the recycle solution, and introducing the mixture of recycle solution and fresh caustic into the tower.

10. A process as set forth in claim 9 including passing the recycle solution through an external heat exchanger to cool it before the addition of fresh caustic.

11. A process as set forth in claim 10 wherein some aqueous hypochlorite product is withdrawn downstream of the heat exchanger before the addition of the fresh caustic.

12. Apparatus for producing aqueous hypochlorite comprising:
a packed tower containing packing;
a supply of liquid comprising caustic;
a supply of gas comprising chlorine;
a system for introducing liquid and gas from the respective supplies into the tower for concurrent flow through the tower, including the packing, to promote reaction of the caustic and chlorine to produce hypochlorite by dispersion of a liquid phase within a continuous gas phase as the liquid and gas pass concurrently through the packing.

13. Apparatus as set forth in claim 12 in which the system for introducing liquid and gas introduces the liquid and gas into the tower vertically above the packing for concurrent flow through the tower in a vertically downward direction.

14. Apparatus as forth in claim 13 in which the system imparts no significant downwardly velocity to the liquid so as to allow gravity to be the dominant force in imparting downward velocity to the liquid.

15. Apparatus as set forth in claim 12 in which the internal pressure within the tower is at or near atmospheric pressure during production of hypochlorite.

16. Apparatus as set forth in claim 12 in which the system introduces both liquid phase and gas phase into the tower free of any de-foaming agent.

17. Apparatus as set forth in claim 12 including a recycle system for recycling, through the tower, the produced aqueous hypochlorite until a desired concentration of hypochlorite results.

18. Apparatus as set forth in claim 17 in which the recycle system comprises a heat exchanger to cool the recycle solution before re-introduction into the tower.

19. Apparatus as set forth in claim 18 in which some of the recycle solution is withdrawn as aqueous hypochlorite product downstream of the heat exchanger preventing its re-introduction into the tower.

20. Apparatus as set forth in claim 17 in which fresh caustic from the liquid supply is added to the recycle solution after the latter has been cooled by the heat exchanger and the mixture of recycle solution and fresh caustic is thereafter introduced into the tower.

21. Apparatus as set forth in claim 20 in which some of the recycle solution is withdrawn as aqueous hypochlorite product downstream of the heat exchanger and before the addition of fresh caustic.
